(19) United States
(12) Patent Application Publication
(10) Pub. No.: US 2003/0171944 A1
(43) Pub. Date: Sep. 11, 2003

(54) Methods and apparatus for personalized, interactive shopping

(76) Inventors: Randall A. Fine, Melbourne Beach, FL (US); John Jablonski, Somerville, MA (US); Dan Cutera, Boston, MA (US); Julie Elder, Groton, MA (US); John Lofgren, Belmont, MA (US); Alan Dziejma, Burlington, MA (US)

Correspondence Address: MCNEES, WALLACE & NURICK, 100 PINE STREET, P.O. BOX 1166, HARRISBURG, PA, 17108-1166, US

(21) Appl. No.: 10/159,350

(22) Filed: May 31, 2002

Related U.S. Application Data
(60) Provisional application No. 60/294,764, filed on May 31, 2001.

(51) Int. Cl. G06F 17/60

(52) U.S. Cl. 705/1

(57) ABSTRACT

A system and application for providing a user with interactive and individualized assistance in selecting an appropriate product for the user based on one or more user-selected goals is provided. The consumer or user accesses the application over a computer network such as the Internet and selects items for purchase from a database. The graphical interface can organize the products, for example, by a pre-selected value, a product category, or the consumer's historical shopping data. The application then reviews the selected products or items and recommends substitutions to help the consumer achieve specified goals. The application also includes additional functionality to permit the consumer to shop on a collection of products basis, e.g. a per-recipe basis for grocery items or a per-outfit basis for fashion or clothing items, to access to current in-store promotions of products or items, and to receive automated notification of promotions that are personalized to the consumer, for example, using historical shopping data or specified goals.

### CROSS-REFERENCE TO RELATED APPLICATIONS

This application claims the benefit of U.S. Provisional Patent Application No. 60/294,764 filed on May 31, 2001.

### FIELD OF THE INVENTION

The present invention relates generally to assisting a shopper make shopping decisions. More specifically, the present invention relates to a system and application for providing a shopper with alternative products in response to a particular product selected by the shopper and a pre-selected goal of the shopper.

### BACKGROUND OF THE INVENTION

Frequently when shopping, a consumer or shopper will attempt to compare several products in order to select the appropriate product for the consumer. One area where the comparison of products by the consumer occurs is in the context of grocery shopping. The consumer compares several food items in an attempt to determine the food item that is appropriate for the user. A consumer may want to select products having low salt or products having high fiber depending on the consumer's particular dietary or nutritional requirements. There are several different ways for the consumer to compare products in order to make a decision.

One technique for comparing products is to compare values from the label information on each of the products. The label information on the products is based on a manufacturer's stated serving size. In theory, the nutrient information in a manufacturer's stated serving size is interesting because it informs the consumer on how much of the nutrient is in a serving in comparison to eating a serving of another food. However, some manufacturers game or adjust the serving size to produce artificial statements on the nutrient content of a serving size. Thus, a scoring system relying on manufacturer serving sizes as the basis for making comparisons favors items with understated serving sizes.

Another technique for comparing products is to calculate an “Average Serving Size” for all items in a related category. First, serving sizes and nutrient amounts are determined for each product. The manufacturer's serving size and nutrient information is used if the manufacturer's stated serving size is larger than the average serving size. The manufacturer's serving size and nutrient information is used if the manufacturer's serving size is smaller than average serving size and there is only 1 serving per package. Finally, a scaled manufacturer's serving size and nutrient information is used when the above two situations have not been satisfied. The manufacturer's serving size and nutrient information is scaled up in the direction of the Average Serving Size, but is not permitted to be scaled up more than 50%.

One problem with the use, of the adjusted serving size is that it cannot effectively account for a compound food product such as a packaged dinner with potatoes, peas, corn, and chicken. For example, a calorie score can be calculated for one serving of each individual component of the compound food product and for one serving of the packaged meal. The result is that the packaged meal gets a much poorer score for lower calories than the sum of its parts because it really represents 4 or 5 servings, not 1 serving.

Another technique for comparing products is to calculate a Nutrient density (Nutrient/Calories) for each product or item. The nutrient density technique is used to resolve some of the comparison problems resulting from the use of serving size information. A nutrient density is calculated for each item by determining the amount of nutrient per calorie or calories per 100 grams for calories. This technique can provide satisfactory results for positive nutrients (calcium, vitamins, etc.), but is not effective for negative nutrients. This technique is not effective for negative or low nutrients because there are two ways to get a good low nutrient score. One way is to have a small amount of the nutrient (e.g. sodium) present in the item, Another way is to have a large amount of calories in the product. Using this technique, bacon can be identified as an excellent low sodium food because it is packed with calories.

Some systems have been developed that can assist a user and consumer in making purchasing decisions. One system store product information, such as nutritional content and weights and measures metrics and can then, as the user selects items for purchase, provide the consumer with accumulated totals for the particular type of information included in the selected items. Another system stores nutritional information on food items along with recipes using the food items and provides the user menus based on a pre-selected diet type.

Therefore, what is needed is an application that can assist a consumer in making shopping decisions by providing the consumer with easy to understand comparison data on products that are not misleading to the consumer.

### SUMMARY OF THE INVENTION

The present invention permits a user to shop interactively, offering substitution recommendations for shopping selections based on a user's past shopping habits and an extensive database of information concerning the goods for sale. In one embodiment, the system lets a user shop for groceries, accepting a nutritional goal and recommending food substitutions in furtherance of that nutritional goal.

One embodiment of the present invention is directed to a method for enabling a user to shop for groceries and nutritional supplements based on predefined nutritional goals. The method includes receiving a predefined nutritional goal and receiving a list of at least one grocery item. The method also includes identifying a grocery item in the list and recommending a substitution for the identified grocery item in furtherance of the received goal.

Another embodiment of the present invention is directed to a method for enabling meal preparation based on predefined nutritional goals. The method includes receiving a first list of at least one nutritional goal and providing at least one recipe for at least one meal in furtherance of the at least one goal in the first list.

Still another embodiment of the present invention is directed to a method for enabling grocery shopping based on predefined nutritional goals. The method including receiving a first list of at least one nutritional goal and presenting a list of groceries highlighting individual grocery items which further the goals in the first list.

Yet another embodiment of the present invention is directed to a method for enabling grocery shopping based on predefined nutritional goals. The method includes receiving a first list of at least one grocery item and presenting nutritional information relating to the grocery item using graphical data.

A further embodiment of the present invention is directed to a method for enabling grocery shopping based on predefined nutritional goals. The method includes presenting textual material comprising at least one of a nutrition-related article or a trivia question to a user. The textual material comprising at least one hyperlink associated with a food item. The method also including responding to the selection of at least one hyperlink to enable the end user to purchase the food item referred to in the at least one hyperlink.

Another embodiment of the present invention is a programmed computer for enabling shopping for groceries and nutritional supplements based on predefined nutritional goals. The computer includes a database of nutritional information directed to at least one of groceries and nutritional supplements and a database of user information comprising the nutritional goals of an individual user.

Still another embodiment of the present invention is directed to a computer program product embodied on a computer readable medium and executable by a computer for executing the steps of: receiving a a first list of at least one nutritional goal; receiving a list of at least one grocery item; identifying a grocery item in the list; recommending a substitution for the identified grocery item in furtherance of the received goal; providing at least one recipe for at least one meal in furtherance of the at least one goal in the first list; presenting a list of groceries highlighting individual grocery items which further the goals in the first list; presenting nutritional information related to the grocery item using graphical data; presenting textual material comprising at least one of a nutrition-related article or a trivia question to a user, wherein the textual material comprising at least one hyperlink associated with a food item; and responding to the selection of at least one hyperlink to enable the end user to purchase the food item referred to in the at least one hyperlink

One advantage of the present invention is that it provides the user with an easy to understand scoring system for comparing products.

Another advantage of the present invention is that the scoring system is generic to a variety of different products, thereby permitting the user to make comparison decisions on different types of products.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a schematic arrangement of a system of the present invention.

FIG. 2 illustrates a schematic arrangement of a network interface and server processes of the present invention.

FIGS. 3A-3K illustrate web pages associated with the use of the application of the present invention.

FIG. 4 illustrates a flow chart showing a process for entering product information into the database of the present invention.

FIG. 5 illustrates a web page for the entry of product label information into the database of the present invention.

FIG. 6 illustrates a web page for the product categorization information into the database of the present invention.

FIG. 7 illustrates a web page for searching the database of the present invention.

FIG. 8 illustrates a web page for displaying the results of a search of the database of the present invention.

FIG. 9 illustrates a web page for editing a data record of an item in the database of the present invention.

FIG. 10 illustrates a schematic of view of information sources to add and update item data records in the database of the present invention.

FIG. 11 illustrates a schematic of view of information sources to add and update data records relating to a consumer's shopping history.

FIG. 12 illustrates a web page for editing a data record of a recipe in the database of the present invention.

Wherever possible, the same reference numbers will be used throughout the drawings to refer to the same or like parts.

### DETAILED DESCRIPTION OF THE INVENTION

The present invention is directed to a system and application for providing a user with interactive and individualized assistance in selecting an appropriate product for the user based on one or more user-selected goals. In a preferred embodiment of the present invention, a consumer or user accesses the application over a computer network such as the Internet. The consumer can select items or products from a database using a graphical interface that organizes the products based on a pre-selected value, a product category, the consumer's historical shopping data, or any other suitable criteria. The application then reviews the consumer selected products or items and recommends substitutions to help the consumer achieve specified goals. The application also includes additional functionality to permit the consumer to shop on a collection of products basis, e.g. a per-recipe basis for grocery items or a per-outfit basis for fashion or clothing items, to access to current in-store promotions of products or items, and to receive automated notification of promotions that are personalized to the consumer based historical shopping data, consumer specified goals or any other suitable criteria.

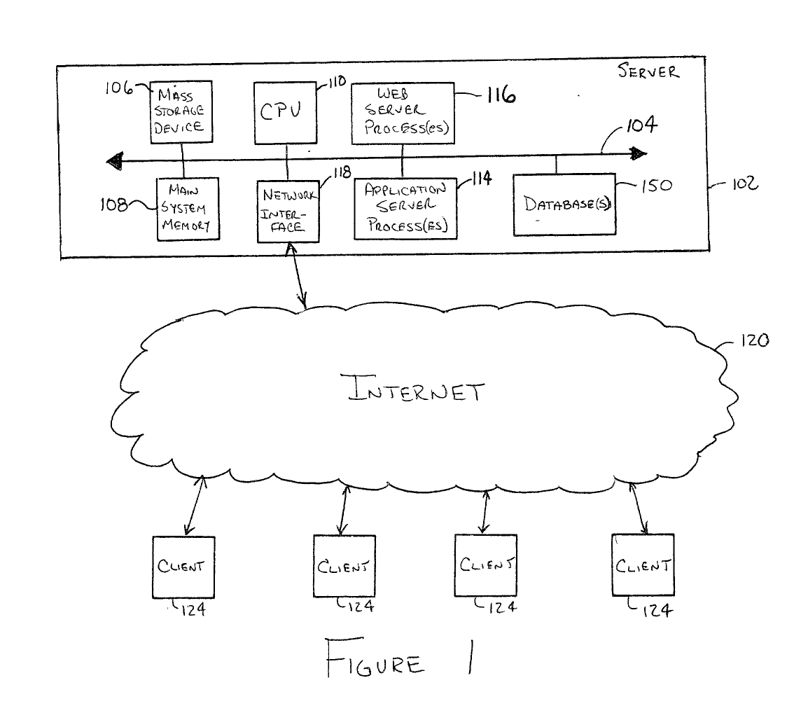

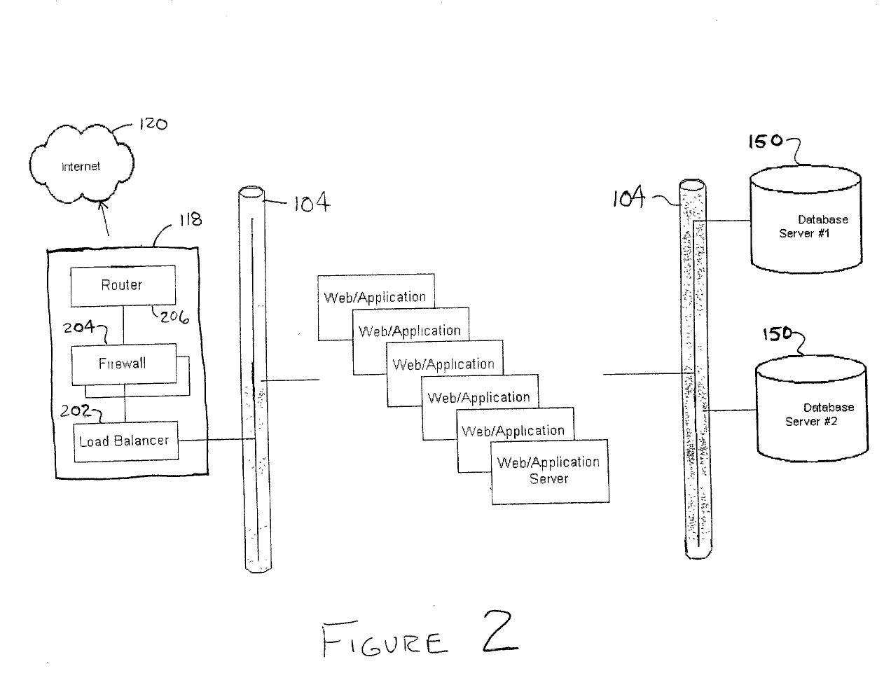

FIG. 1 illustrates a schematic arrangement of one embodiment of the system of the present invention. The system includes one or more server computers 102 connected by a computer network 120 to at least one client computer 124. The server 102 can preferably store and implement an application to provide a user with interactive and personalized shopping assistance by providing the user with alternate product selections based on a pre-selected criteria of the user. The shopping assistance application communicates with a database(s) 150 that stores information relating to products or items available for purchase. The database(s) 150 can be stored on the server computer 102, but can also be stored on another computer that is connected to and accessible by the server computer 102, e.g. another server computer. The shopping assistance application and the database(s) 150 can be accessed on the server computer 102 by users or consumers from the client computers 124.

In a preferred embodiment of the present invention, the shopping assistance application is implemented as a network application that is executed in a web browser on the client computers 124 of the user or consumer. The shopping assistance application can be executed on the client-side, the server-side or on both the client-side and the server-side. In another embodiment, each client computer 124 on the computer network 120 may store an individual copy of the shopping assistance application, which can access the corresponding database(s) 150 stored on the server computer 102. In an alternate embodiment of the present invention, the shopping assistance application can be a network application that is executed in a windows or other similar environment. In this embodiment, instead of loading and viewing web pages, a user would load and view windows or screens.

The computer network 120 is preferably the Internet, however any other type of network can also be used, for example, an Extranet, a local area network (LAN), a wide area network (WAN) or an Intranet. The client computer 124 and server computer 102 can be any type of general purpose computer having memory or storage devices (e.g. RAM, ROM, hard disk, CD-ROM, etc.), processing units (e.g. CPU, ALU, etc.) and input/output devices (e.g. monitor, keyboard, mouse, printer, etc.). The general purpose computer may also have communication devices (e.g. modems, network cards, etc.) for connecting or linking the general purpose computer to other computers.

In a preferred embodiment of the present invention, the shopping assistance application is stored or resides on the server computer 102 in a mass storage device (such as a hard disk or optical storage unit) 106 as well as in a main system memory 108 during execution of the shopping assistance application by a central processing unit (“CPU”) 110 of the server 102. Within the server 102, a network interface 118 is used to connect the server 102 to the Internet 120. The components of server 102 intercommunicate over a bi-directional system bus 104.

In one embodiment shown in FIG. 2, the network interface 118 includes a load balancer 202, a firewall 204, and a router 206. The load balancer 202 is preferably used in an environment where there are multiple web server processes 116 or multiple application server processes 114, such as a shopping application server process, incorporated into the server 102. The load balancer 202 accepts an incoming request from a customer on the web, identifies the state of a server process as busy or idle, and assigns the incoming request to an idle process for further processing. The firewall 204 secures the server 102 and website against malicious external activity using well-known techniques. The router 206 sends data to the correct target machine on the Internet using control information encoded in the information.

The CPU 110 is controlled by a series of executable instructions incorporated as a series of interacting modules programs stored or residing within the main system memory 108. An operating system directing the execution of low-level basic system functions including memory allocation, file management, and operation of mass storage devices 106 is stored on a mass storage device 106 and/or, the main system memory 108. The web server software process module 116 is preferably used for communicating over the Internet or Web, thus making web pages stored on the server 102 accessible to consumers over the Internet 120. Communication over the Internet 120 is accomplished by segmenting information for transfer into data packets. Each packet is assigned a destination address according to a consistent protocol, transmitted, and is reassembled upon receipt by the target computer. A commonly accepted set of protocols for this purpose includes Internet Protocol (“IP”) and transmission control protocol (“TCP”). IP specifies routing information and TCP specifies how messages are actually broken up into IP packets for transmission, subsequent collection, and reassembly.

The Internet supports a large variety of information-transfer protocols, including hypertext transfer protocol (HTTP), which the primary protocol of the World Wide Web. A uniform resource locator (URL) identifies Web-accessible information, specifying the location of the file in terms of a specific computer and a location on that computer. Any Internet “node,” that is, a computer with an IP address, can access a file by invoking the proper communication protocol and specifying the URL. Typically, a URL has the format http://<host>/<path>, where “http” refers to hypertext transfer protocol, “host” is the server's Internet identifier, and the “path” specifies the location of the file within the server.

One type of file accessible through a URL is a hypertext markup language (HTML) file, commonly referred to as a web page. In the present invention, the mass storage device 106 and the database(s) 150 store various aspects of one or more webpages for use with the shopping assistance application. The aspects of the webpages of the shopping assistance application include formatting or display instructions, “applet” instructions that cause a properly equipped remote device, such as a computer, to present a dynamic display, and other appropriate web page instructions.

The connection between the Internet 120 and the client 124 and the Internet 120 and the server 102 may take many forms. Typical examples include high-speed dedicated lines as well as simple dial-up connections. In one embodiment of the present invention, the connection between the Internet 120 and the client computer 120 can be a wireless link or connection. In this embodiment, a wireless client such as a PDA or wireless communication device is able to use the shopping assistance application of the present invention.

In another embodiment of the present invention, the shopping assistance application and database(s) 150 can be executed without any requirement for a network connection. The shopping assistance application can be executed from an internal memory or storage device, e.g. RAM, ROM, hard disk, etc., of the client computer 124 of the user in either a web browser as discussed above or in an operating system environment, such as a Windows environment, a Linux environment or a Unix environment. The shopping assistance application and database(s) 150 can be loaded into the internal memory of the user's computer from a portable medium such as a CD-ROM, DVD-ROM, floppy disk, etc., that is inserted into the computer. Alternatively, the shopping assistance application and database(s) 150 can be transferred or loaded directly into the internal memory of the user's computer through an electronic connection with another computer that has a stored copy of the shopping assistance application and database(s) 150. In other words, the shopping assistance application and database(s) 150 can be downloaded to the user's computer from another computer over a network connection or an Internet connection and then can be operated without the network connection. The user is able to use the shopping assistance application without a network connection and is able to store product selections and related information and documents. However, the user has to reestablish a network connection to receive updated product information for the shopping assistance application and to transfer the user's information and selections to the database(s) 150 on the server 102.

In a preferred embodiment of the present invention, the shopping assistance application is used to provide a consumer assistance in selecting grocery items. However, it is to be understood that the shopping assistance application can be adapted to provide a consumer assistance in selecting any type of product or item for purchase.

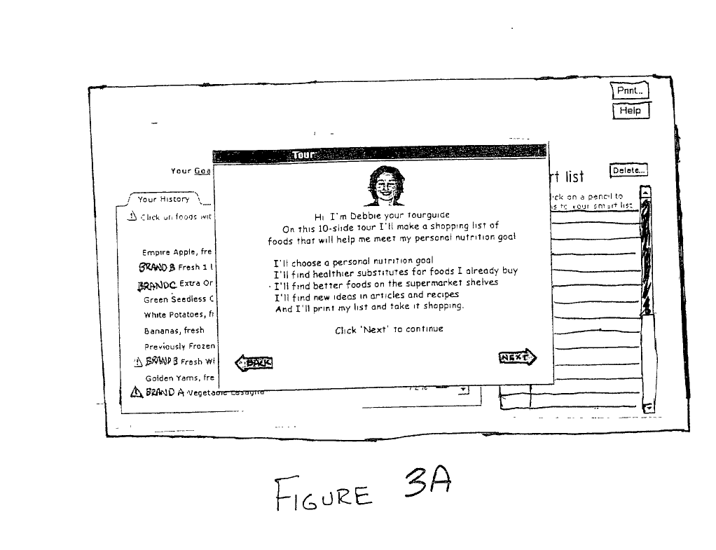

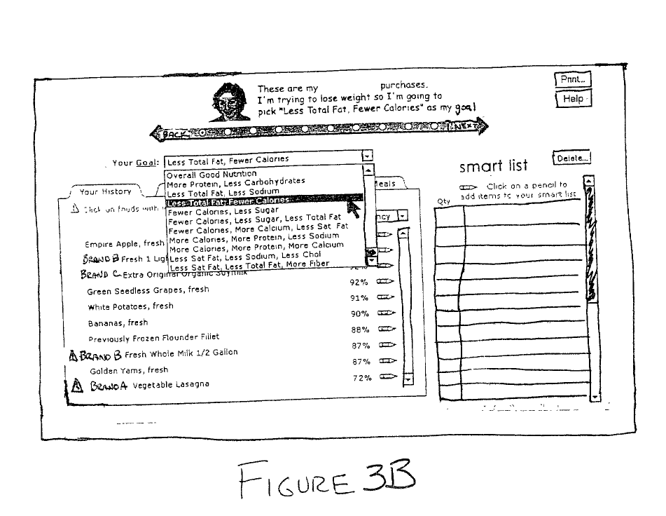

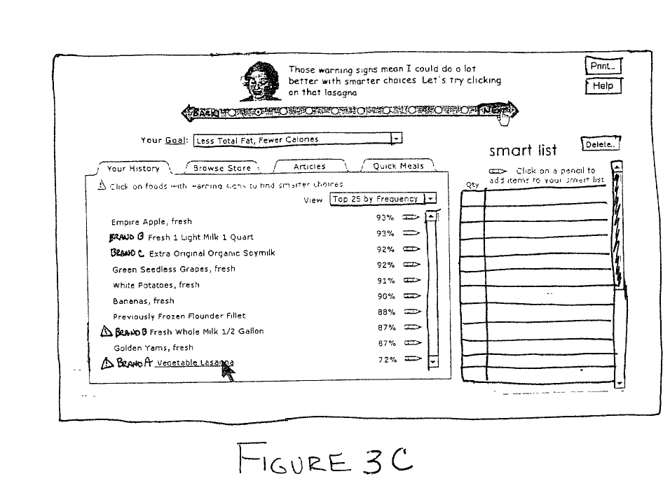

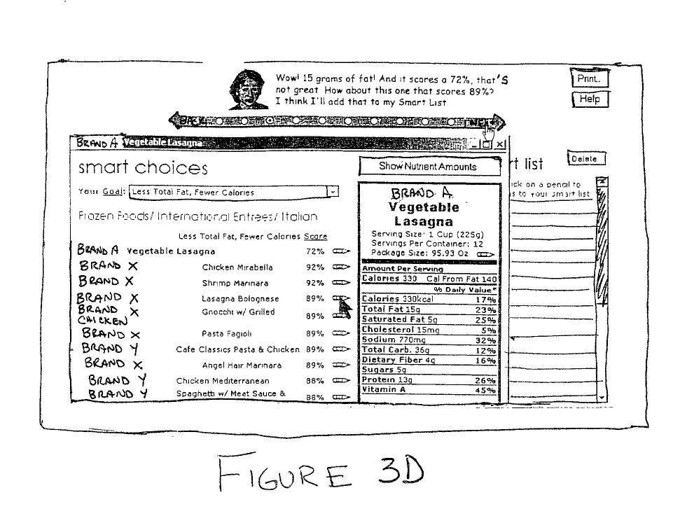

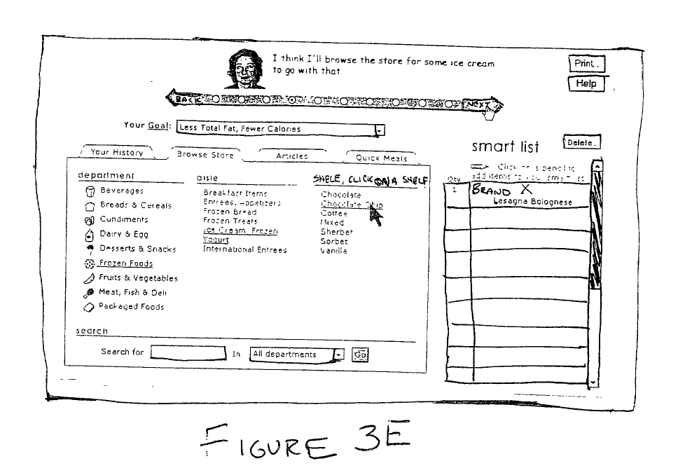

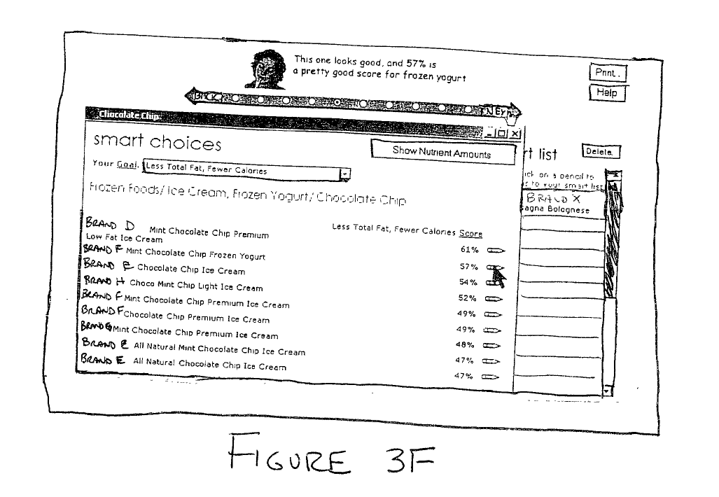

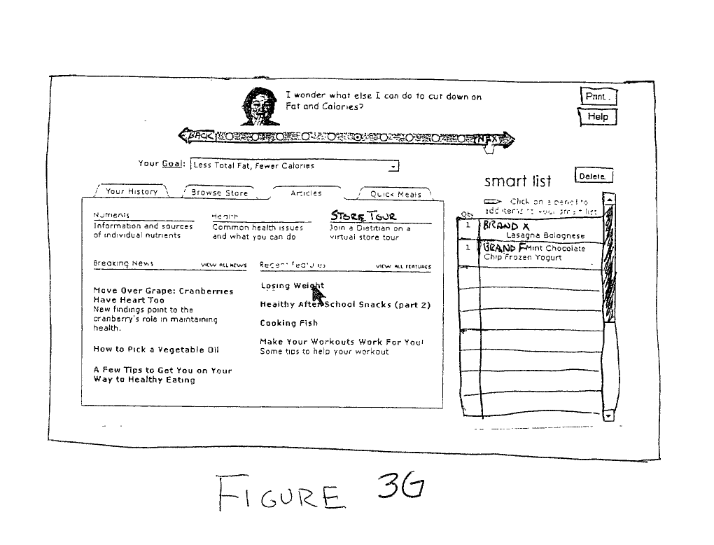

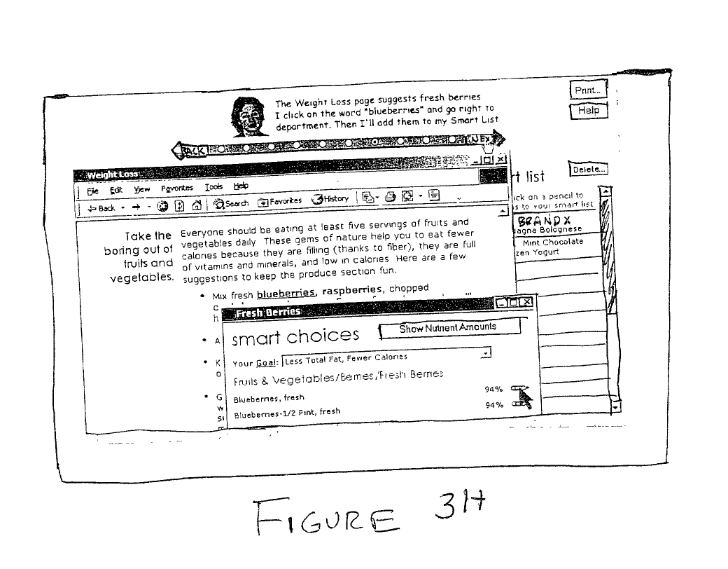

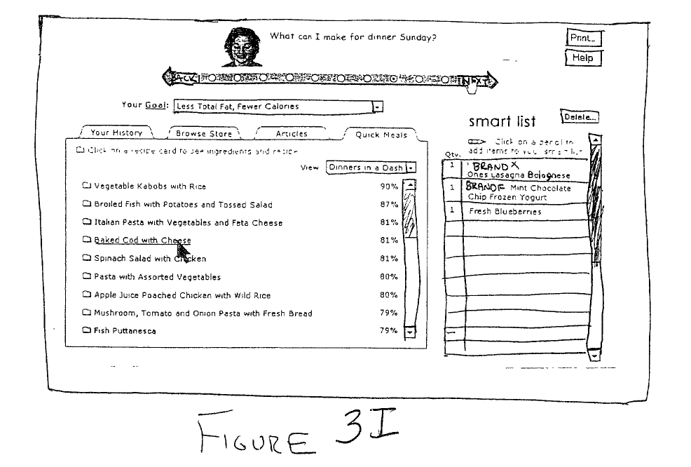

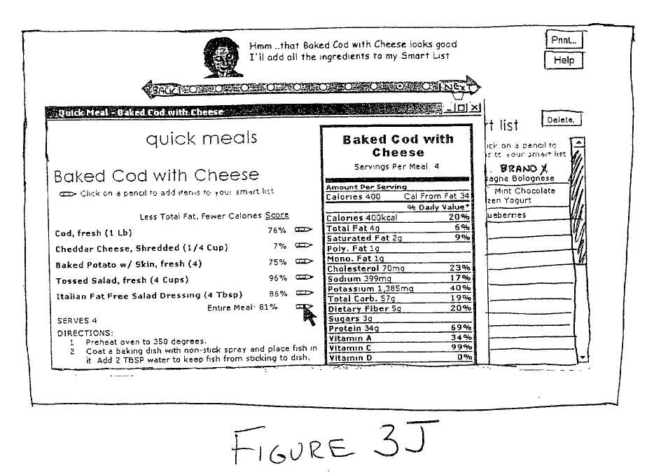

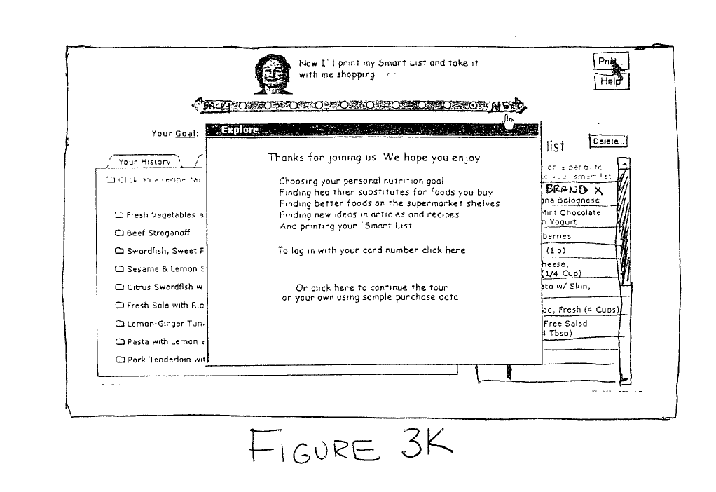

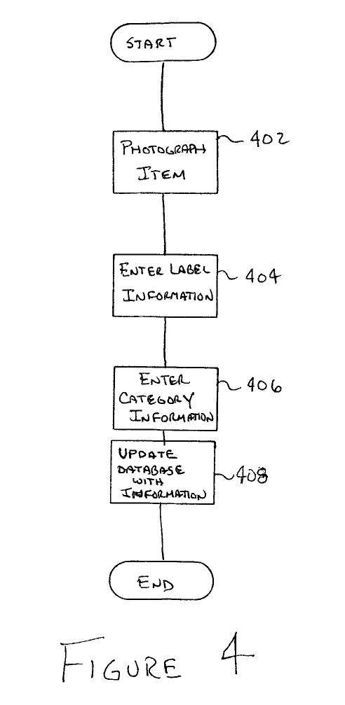

FIGS. 3A-3K illustrate an interaction between an end user or consumer and a server 102 in one embodiment of the present invention. The user at the client computer 124 has initiated a connection with the server 102 via the Internet 120 using one of a modem, xDSL connection, broadband connection, WAP link, etc. The user at the client computer 124 launches a web browser such as OPERA, NAVIGATOR, or INTERNET EXPLORER that requests and receives web pages from the server 102 in response to the execution of the shopping assistance application.

FIG. 3A illustrates a welcome or introduction screen or web page of the shopping assistance application. FIG. 3B illustrates a web page permitting the user to specify or select at least one goal that is used by the shopping assistance application to determine appropriate alternate or substitute products for the consumer. For example, the consumer can select a desired nutritional goal or other suitable goal such as a value goal. Some example of nutritional goals include: products providing overall good nutrition; products providing more protein and less carbohydrates; products providing less total fat and less sodium; products providing less total fat and fewer calories; products providing fewer calories and less sugar; products providing fewer calories, less sugar and less total fat; products providing fewer calories, more calcium and less saturated fat; products providing more calories, more protein and less sodium; products providing more calories, more protein and more calcium; products providing less saturated fat, less sodium and less cholesterol; and products providing less saturated fat, less total fat and more fiber. Other nutritional goals may also be provided including other combinations of previously listed goals and different types of nutritional goals. The user can select several goals simultaneously or select predetermined combinations of goals. In another embodiment, a set of nutritional goals is determined based on medical information provided by the user or the user's physician through medical records or a computer-based interview.

The goal of “Less Total Fat, Fewer Calories” is highlighted for selection in FIG. 3B. Upon selection of this goal, the shopping assistance application evaluates the user's past food purchases and current food selections in view of this selected goal. Using a database of stored nutritional information and weighted scoring algorithms, as discussed in further detail below, a food item is rated according to how many calories it provides and how much fat it contains. The rating process is dynamic as the user may select a new nutritional goal, thereby changing the scores of the particular food items displayed. For example, a bag of salt-free potato chips that scores well when the goal is “Less Sodium” may score poorly when the goal is “Less Fat” or “Less Calories.”

FIG. 3C illustrates a product selection web page for the user in response to the specification or selection of at least one goal. The user shops by graphically selecting grocery items that can be organized in several different arrangements. The grocery items can be organized hierarchically based on food category, based on recipe types and ingredients or based on the consumer's shopping history. When based on the consumer's shopping history, the grocery items can be organized by selecting a record of a past grocery shopping trip for use as a baseline shopping list, or by selecting an aggregation of past grocery shopping trips for use as a baseline shopping list. In FIG. 3C, the grocery items are organized using an aggregation of past grocery shopping trips and specifically the items are organized using a list of the consumer's 25 most-purchased items. Other arrangements of grocery items based on the consumer's shopping history can be based on date of purchase of items, price of purchase of items, aggregate amount purchased, etc.

As discussed in further detail below, the shopping assistance application evaluates each of these grocery items in light of the specified goal of “Less Total Fat, Fewer Calories.” The grocery item “Brand B Fresh 1 Light Milk 1 Quart” has a score of 93%, indicating that it has less fat and fewer calories than, for example, the “Golden Yams, Fresh.” which has a score of 87%. The grocery items have been sorted by their score from highest to lowest, to facilitate customer identification of those foods that either most help or most hinder the consumer's progress towards the specified nutritional goal.

The shopping assistance application also compares individual grocery items with other grocery items in the same category, marking the item with a symbol, e.g. a yellow caution symbol, if the grocery item can be substituted for a grocery item with a higher score in view of the selected nutritional goal(s). In another embodiment, the substitute grocery items can be predetermined by a nutritionist or can be determined by monitoring other users' substitution selections.

In the list of FIG. 3C, two items are marked with caution signs or symbols. The caution symbol indicates that the item can be replaced by other food items that would help the user better achieve the specified goal of “Less Total Fat, Fewer Calories.” Upon the selection of “Brand A Vegetable Lasagna,” which item has been marked with a caution symbol, by the user, the user is provided with information relating to the item. FIG. 3D illustrates a web page providing the user with information related to a selected product. A computer graphic representation of a label of the item is provided to show the calories and nutritional information per serving of the selected food item. The web page also presents a list of potential replacements for the selected food item, scored according to the specified nutritional goal and sorted from highest to lowest score.

As shown on FIG. 3D, the lasagna has been precategorized as a “Frozen Food.” Within the grandparent class of all “Frozen Food”, the lasagna has been further identified as an “International Entrée.” Similarly, within the parent class of all “International Entrees,” the lasagna has been identified as “Italian.” The potential substitute foods items are determined from the other food items in the same category, scored and ranked in order of which items best fulfill the nutritional goal of “Less Total Fat, Fewer Calories.” The user can select and identify an alternate food item such as “Brand X Lasagna Bolognese” as a desirable replacement for the vegetable lasagna and can add the alternate grocery item to a virtual shopping list (see FIG. 3E) by selecting an icon associated with the item, such as a pencil icon.

As discussed above, the user can select food items by browsing a hierarchically-ordered set of groceries representative of a virtual grocery store by selecting an appropriate tab, such as a “Browse Store” tab. FIG. 3E illustrates a web page for browsing or navigating hierarchically organized grocery categories. In one embodiment, the user can select a department category, an aisle category and a shelf category to attempt to locate an item of interest. As shown in FIG. 3E the user has selected the “Frozen Foods” department category, the “Ice Cream, Frozen Yogurt” aisle category and the “Chocolate Chip” shelf category to locate ice cream to supplement the selected dinner entree. One embodiment of the shopping assistance application implements this user interface by downloading an interactive grocery hierarchy to a client web browser using JavaScript, a Java applet, an ActiveX control, a Java Bean, or some other mechanism known to the art. A dialog box element at the bottom of the web page permits the user to search for a specific food item by entering a full or partial text name.

In response to the user selection of a shelf category, all of the items in the shelf category are displayed. FIG. 3F illustrates a list of grocery items in for the “Chocolate Chip” shelf category stored in the database. The shopping assistance application, presents all of the grocery items scored with respect to the user's specified goal of “Less Total Fat, Fewer Calories” and sorted from highest to lowest score to facilitate selection by the user. As shown in FIG. 3F, the user can choose “Brand F Mint Chocolate Chip Frozen Yogurt” with a score of 57% and select the pencil icon to add the item to the virtual grocery list (see FIG. 3G).

The user may also shop for grocery items using a set of shopping-enabled nutritional articles. FIG. 3G illustrates a web page providing a user with a selection of articles and article categories from an article database. The articles are preferably organized chronologically, however, the articles can be organized according to the user's past shopping purchases or selected nutritional goals. In response to the selection of an article from the web page illustrate in FIG. 3G, the user is presented with the full text and information relating to the article. FIG. 3H illustrates a web page providing the user with the full text and information of the selected article. The information in the article identifies food items that can potentially help a user lose weight. The user can select a particular food item and the shopping assistance application can retrieves every entry for the food item from its database, rates the items according to the user's specified nutritional goals, and presented the items sorted by their scores. In one embodiment, the food items can be underscored and colored to indicate that the user can select that item to add the item to the user's virtual shopping list. As shown in FIG. 3H, the user can select “blueberries” and add the item to the user's virtual shopping list (see FIG. 31).

The user can also shop for grocery items on a per-recipe or per-meal basis. FIG. 31 illustrates a web page providing the user with a selection of recipes and recipe types from a database. The user can access the recipe web page by selecting a tab, e.g. the “Quick Meals” tab, and then filter the recipes displayed on the recipe page by selecting a particular type of recipe, e.g. “Dinners in a Dash,” for a plurality of recipe types. The shopping assistance application then retrieves all the meals and recipe entries in its database that have been previously categorized in the user's selected recipe type, scores the recipes according to the user's specified nutritional goal, and presents the recipes sorted by score. As shown in FIG. 3I “Vegetable Kabobs with Rice” has a 90% score relative to the user's goal of “Less Total Fat, Fewer Calories” and “Baked Cod with Cheese” has a score of 81%.

Upon the selection of a recipe, the user is presented with a list of ingredients in the recipe, cooking instructions, aggregate nutritional information for the entire meal both in absolute and USDA relative values, and scoring information for individual ingredients in the recipe in view of the user's specified nutritional goals. FIG. 3J illustrates a web page providing the user with detailed information on a recipe selected by the user. The user can add all the ingredients of the recipe to the shopping list by selecting the pencil icon adjacent to the “Entire Meal” score, or can add a particular ingredient to the shopping list by selecting the pencil icon adjacent to that individual ingredient. In one embodiment a particular grocery items can be highlighted or marked for substitution to better achieve the user's specified nutritional goal and to engage in a substitution dialog, as discussed above. In another embodiment, the shopping assistance application can filter the recipe and meal selections using the user's historical shopping data or avoidance preferences. For example, the shopping assistance application may only present those recipes or meals that include ingredients that the user will purchase or has purchased at some time in the past. Similarly, the shopping assistance application would not present recipes or meals containing either ingredients on the user's avoidance list or ingredients that the user has never purchased.

After completing grocery selection using one or more of the options discussed above, the user has several options to fulfill his or her grocery order. In one embodiment the user prints the shopping list and uses it while shopping (see FIG. 3K). In another embodiment the user transmits the shopping list electronically to a grocery store or grocery vendor for fulfillment and pick-up or delivery. FIG. 3K illustrates a closing web page of the shopping assistance application that can print or transmit the user's virtual shopping list.

The shopping assistance application preferably uses historical shopping data associated with a user. In one embodiment, the historical shopping data can be retrieved from a smartcard. In other embodiments, the historical shopping data is stored at a central database(s) 150 and retrieved upon authentication of the end user using, for example, a known password, a shared secret hierarchy, biometrics, etc. The user can belong to a “loyalty program” offered by the vendor operating the server 102 and the shopping assistance application. The user can enter his or her loyalty program number as an identifier, whereupon the shopping assistance application takes additional steps to verify the user's identity or proceeds to obtain information concerning the user's past purchases from the database 150.

In a preferred embodiment of the present invention, the database 150 includes data from multiple sources. In one embodiment, the database 150 includes historical purchase data for individual users, loyalty card information for individual users, nutritional information for grocery items offered for sale, and lists of ingredients for recipes or complete meals. In another embodiment, the database(s) 150 includes a table of food ingredients a user wishes to avoid (user avoidance list), a grocery categorization hierarchy, and various precomputed metrics to enable the grocery substitution feature, as discussed in further detail below. Additional data sources of disparate types can be identified and integrated into the shopping assistance application.

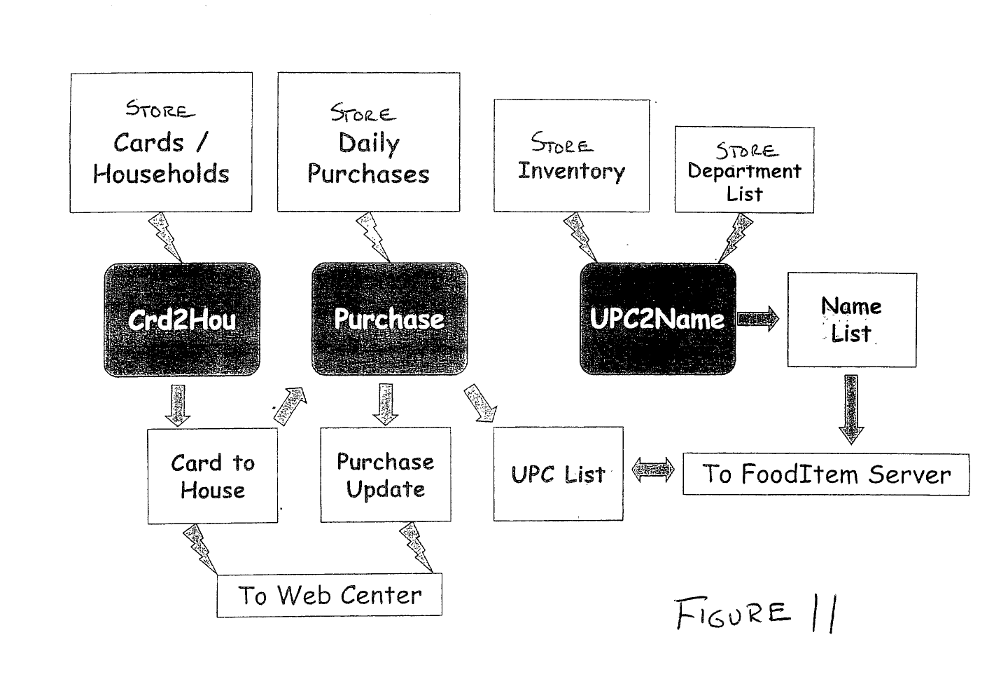

The shopping assistance application can periodically receives updates of loyalty card information. The shopping assistance application compares the set of loyalty card numbers received in the update against the present list of loyalty card numbers and updates the database to add any new loyalty card numbers. In a preferred embodiment, the shopping assistance application receives, on a daily basis, a list of grocery purchases from a store partner for automated conversion to a proprietary data format and subsequent analysis and use as historical shopping data, as discussed above. FIG. 11 illustrates schematically some of the sources of information that can supply information to the database 150 for adding and updating the consumer's historical shopping data and the available products or items at the store.

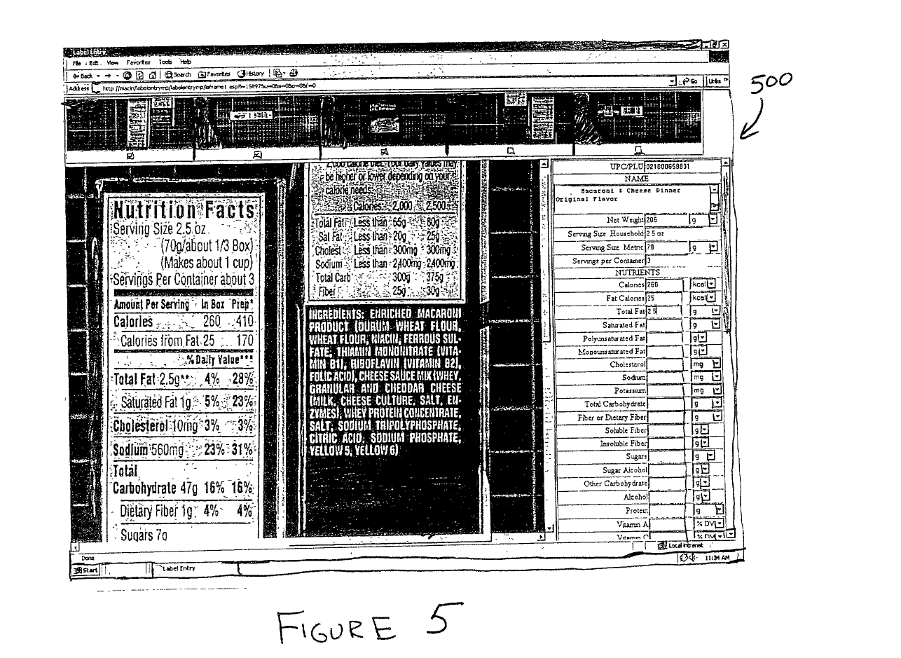

FIG. 4 illustrates the basic process for entering label information into the database 150 for a selected food item. The process begins with the photographing of all sides of the selected item in step 402. The food items are preferably photographed against a grid backdrop, however, any suitable backdrop can be used. The photographs are then reviewed for legibility and accuracy before conversion to a computer-readable format, such as graphics interchange format (GIF) or portable network graphics (PNG) format, or other suitable format.

Next, in step 404, information from the labels of the selected food item is entered. Preferably, two or more trained individuals or data entry specialists review the photographs, preferably as graphical image files, of the selected food item, determines relevant product information, and manually enter the data from the labels of the selected food item into the database 150. FIG. 5 illustrates a web page 500 or program screen for the entry of label information into the database(s) 150, which label information preferably includes nutritional and grocery information. As shown in FIG. 5, the label information entry web page 500 can include the graphical image files of the selected food item and a plurality of fields for the entry of information relating to the selected food item. The plurality of fields provided to the data-entry specialist on label information entry web page 500 correspond to the fields of the record in the database 150.

A database record for an individual grocery item can include fields for the item's UPC code, name, net weight, serving size (household and metric), number of servings per package, price, ingredient list, and other fields present on the label of an item in a grocery store. In addition, the database record includes fields for the amount of each nutrient included in the food item, such as: calories; fat calories; total fat; saturated, unsaturated and polyunsaturated fats; cholesterol; sodium; potassium; carbohydrates; fiber, soluble fiber and insoluble fiber; sugar; sugar alcohol; protein; ash; calcium; phosphorus; iron; magnesium; zinc; copper; manganese; selenium; vitamins A, E, B6, B12, and C; thiamin; riboflavin; niacin; pantothenic acid; folate; and water content, among others. As discussed above, the fields from the database record are provided to the data-entry specialist on label information entry web page 500 for the entry of product information.

In another embodiment of the present invention, automated character recognition software can be used to enter label information into the database 150. The character recognition software identifies alphanumeric characters in the data file, which data file was generated from the photograph of the selected item, and can correlate the characters to the appropriate fields in the database record, thus permitting step 404 to be completed automatically. While the automatic entry of information into the database reduces the amount of manual entry of information by trained personnel, the automatically entered information will still have to be proofed by the trained personnel.

Referring back to FIG. 4, the categorization information of the selected item is entered in step 406. In other words, the selected item is categorized into an appropriate predetermined category in step 406. Preferably, two or more trained individuals or data-entry specialists view the photograph of the selected item and categorize the selected item in the appropriate categories, preferably including grandparent, parent, and child categories. FIG. 6 illustrates a web page 600 or program screen for the entry of category information into the database(s) 150, which category information preferably includes a title for the selected item, a packaging category, one or more product categories, and an indicator that the selected item is a store brand. As shown in FIG. 6, the category information entry web page 600 can include the graphical image files of the selected food item and a plurality of fields for the entry of category information relating to the selected food item.

To enter the category information for the selected item, the data-entry specialist starts by assigning the selected item a parent category. Next a child category is entered for the selected item. The data-entry specialist can also enter the grandparent category or alternatively, the grandparent category can be determined automatically in response to the selection of the parent and child categories. If appropriate, a package qualifier can be entered for the selected item. The package qualifier is related to the type of packing used or the condition of the selected item. Some examples of package qualifiers include box, bottle, can, jar, fresh and frozen. The data-entry specialist can also indicate if the selected item is a store brand or a generic item. Finally, the data-entry specialist has to enter a name for the selected item, which product name will be used by the consumer to identify the product.

The grocery items in the database 150 are hierarchically-organized in a multilevel tree structure. As discussed earlier, this structure appears when a user selects the “Browse Store” tab. Each grocery item has a grandparent category, a parent category, and a child category. The combination of these categories form a logical and convenient representation to organize the groceries present in a typical grocery store. Grandparent categories are analogous to the departments in a supermarket and include: “Beverages,” “Breads & Cereals,” “Condiments,” “Dairy & Egg,” “Desserts & Snacks,” “Frozen Foods,” “Fruits & Vegetables,” “Meat. Fish & Deli,” “Packaged Foods,” and any other suitable department. Parent categories are associated with a particular grandparent category and are analogous to aisles in the department of a supermarket. For example, if the grandparent category department is “Frozen Foods,” an appropriate set of parent categories/aisles are: “Breakfast Items,” “Entrees, Appetizers,” “Frozen Bread,” “Frozen Treats,” “Ice Cream, Frozen Yogurt,” and “International Entrees.” Child categories are associated with particular parent categories and are analogous to the shelves in the aisle of a department in a grocery store. For example, if the parent category is “Ice Cream, Frozen Yogurt” then an appropriate set of child categories includes: “Chocolate,” “Chocolate Chip,” “Coffee,” “Mixed,” “Sherbet,” “Sorbet.” and “Vanilla.” Accordingly, all the chocolate chip ice cream grocery items would be associated with the grandparent category “Frozen Foods,” the parent category “Ice Cream, Frozen Yogurt,” and the child category “Chocolate Chip.” In one embodiment of the present invention, individual grocery items are associated with multiple grandparent, parent, or child categories. Additional information regarding the types of tables, columns and records in the database relating to the entry of label and category information for a product is located in Addendum A attached hereto.

Finally, the database 150 is updated with the entered information and photographs of the selected product in step 408. In another embodiment, the database 150 can be updated after the entry of category information or the entry of label information. Data entry errors are identified by comparing the data, both category and label, entered by multiple specialists from an identical image file. Irresolvable inconsistencies result in the marking of the record as requiring special attention. Information concerning the images themselves and the creation and editing of data records are themselves stored in another database. Similarly, recipes or meals may be entered by trained individuals or through scanning and optical character recognition using a similar process to the one described above.

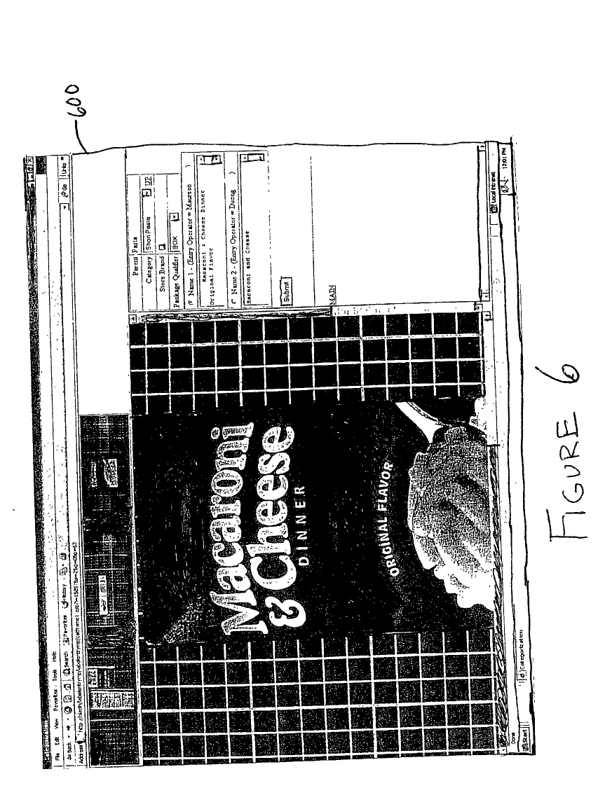

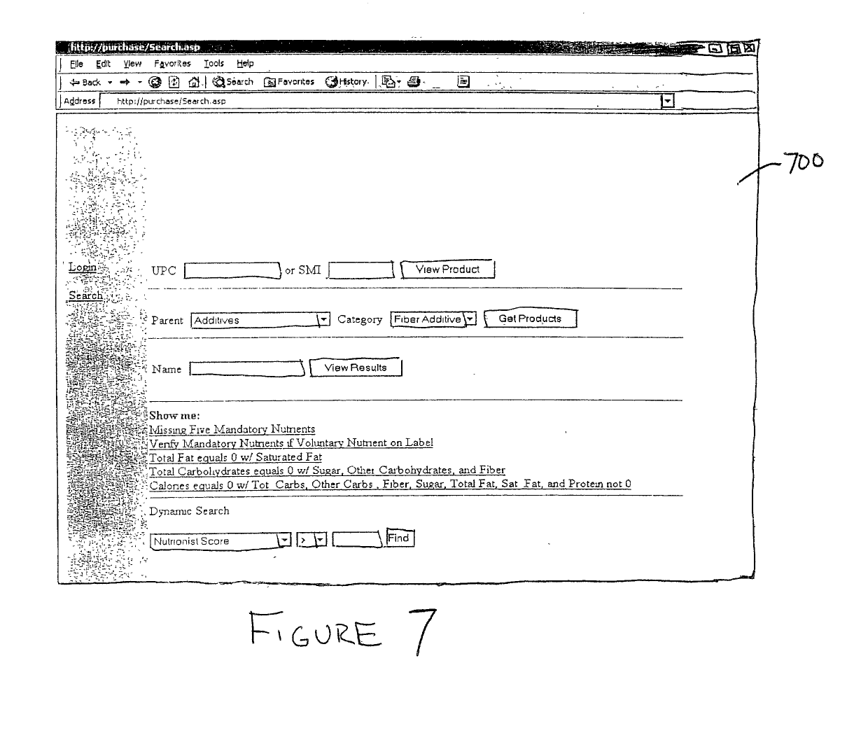

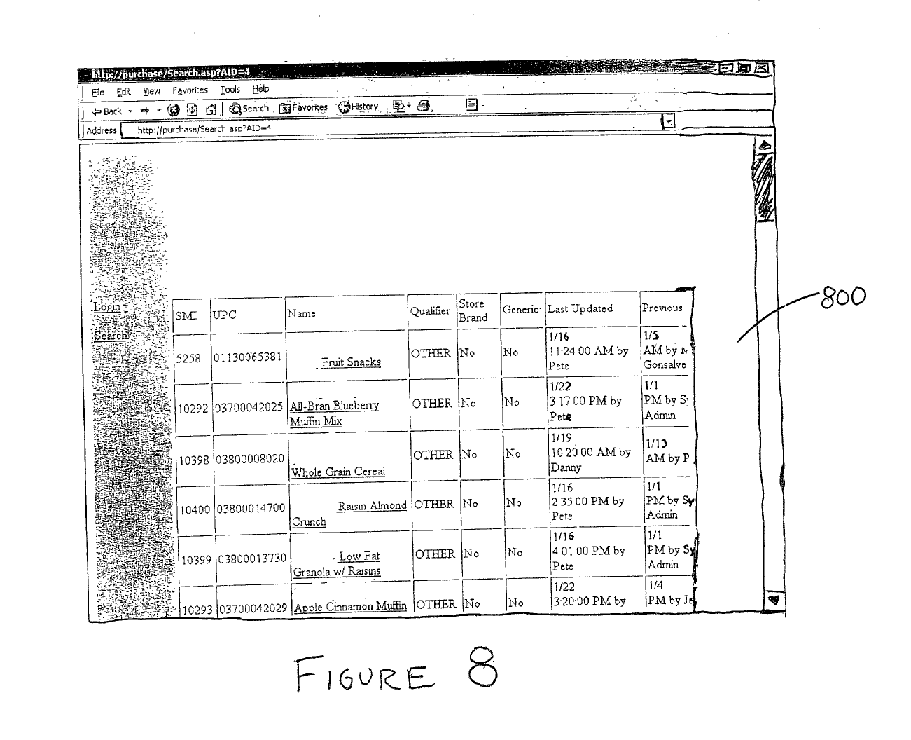

After the initial entry of item information into the database as described above, item information can be reviewed and updated, as appropriate, to maintain the information in the database 150 as accurate as possible. FIG. 7 illustrates a web page 700 or screen of the shopping assistance application that permits privileged or authorized administrative users to search the product entries in the database 150 by UPC code, proprietary index (SMI) value, parent category, child category, product name, or combinations of various nutritional goals. In another embodiment of the present invention, the search web page 700 can be provided to consumers to permit the consumers to search the database 150 for products or items of interest.

FIG. 8 illustrates a web page 800 or window of the shopping assistance application that provides the authorized administrative user with the results of a search submitted using search web page 700. The search results web page 800 permits the administrative user to view multiple food items in a single table or format. Some of the information provided to the administrative user on search results web page 800 includes UPC code, proprietary index (SMI) value, product name, product qualifier, store brand indicator, generic brand indicator and previous update information. An administrative user with appropriate authorization or privileges can select an item from the search results web page 800 for editing the database records associated with a food item.

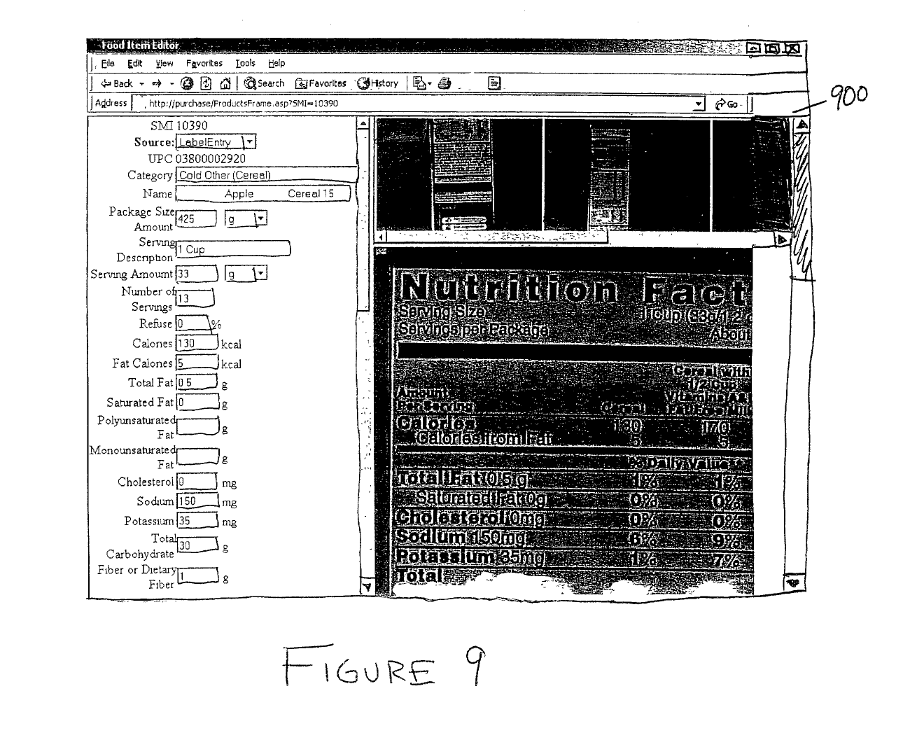

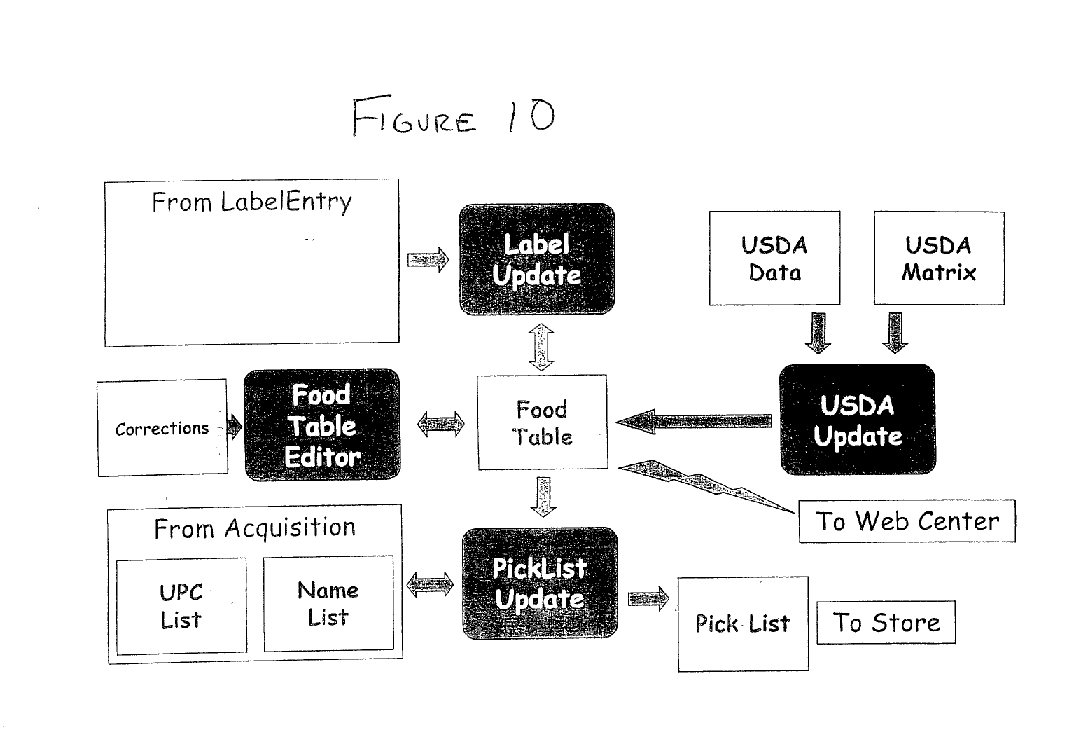

FIG. 9 illustrates a web page 900 or window of the shopping assistance application for an authorized administrative user to edit existing food item information in the database and to enter new food item information into the database. The edit information web page 900 permits the authorized administrative user to edit any of the fields of the database record for the particular food item of interest. The administrative user can view the images of the particular food item of interest to assist in making the appropriate changes to the database record. After the administrative user has completed making changes to the database record for the particular food item of interest, the database will record and maintain a history of the records that have been modified.

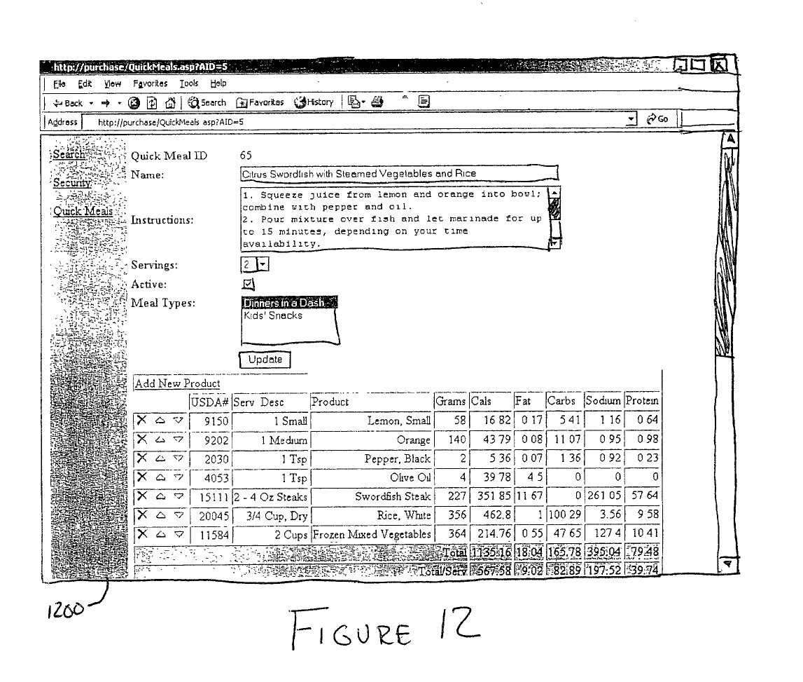

In another embodiment of the present invention, recipe information in the database can be searched and edited in a similar fashion to the searching and editing of product information described above. FIG. 12, illustrates a web page 1200 for editing a selected recipe from the database. The administrative user is able to modify the ingredients, instructions, meal type and servings associated with the recipe. As the information in the recipe is edited, the total amounts for the recipes are automatically calculated to reflect any changes in the nutrient information.

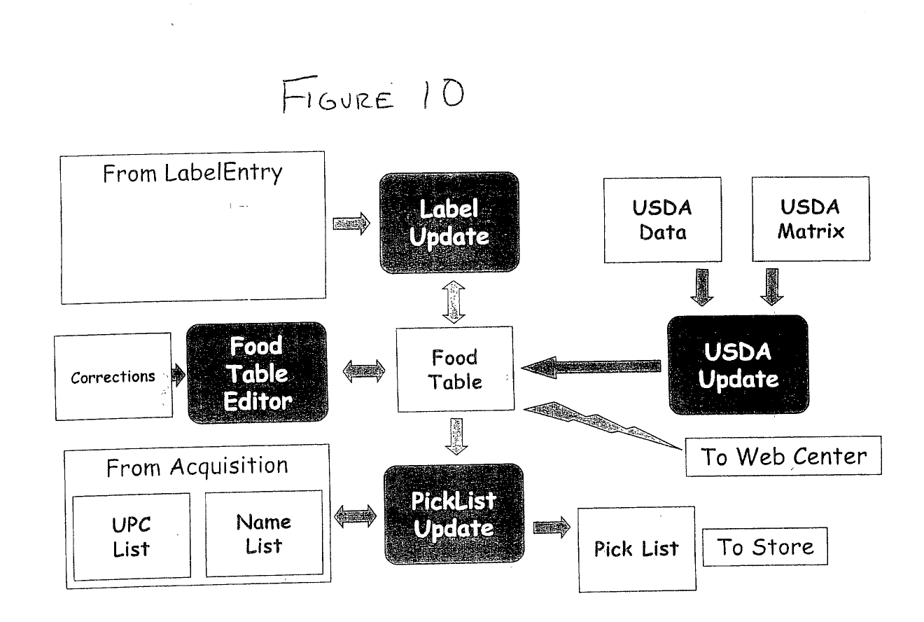

As discussed above, the database 150 can be supplemented by entering item product information using the label entry subsystem of the shopping assistance application as discussed in detail with respect to FIGS. 4-6. The database 150 can also be updated by using the food item editor of the shopping assistance application as discussed in detail with respect to FIGS. 7-9. Additionally, the database 150 can be updated or supplemented with United States Department of Agriculture (USDA) information. The USDA information is preferably in a spreadsheet format that can be interpreted by the database 150 and preferably includes the UPC, product name, categorization, and USDA number. The database 150 can also be updated or supplemented using a spreadsheet overlay. The spreadsheet overlay can include the proprietary index value and the revised product data and is used to change the information in particular fields of particular records of the database. FIG. 10 illustrates schematically some of the sources of information that can supply information to the database 150 for adding and updating the product or item information data records.

Additional records in the database 150 are used with other functionalities or features of the shopping assistance application. One embodiments of the present invention includes a table of food ingredients that a user might wish to avoid. These food ingredients can include potential food allergens such as nuts; foods prohibited for medical reasons such as eggs or lactose-containing foods; foods proscribed for religious reasons such as beef or pork; and other food items that the user wishes to avoid such as monosodium glutamate (MSG) or saccharine. If the user specifies a particular ingredient to avoid, the shopping assistance application highlights past and present grocery selections that include the specified ingredient, permitting the user to invoke a substitution dialog as discussed in detail above. In one embodiment, the presence of the specified ingredient is determined by a full text search of the lists of ingredients of the grocery items currently presented to the user for selection. In another embodiment, the presence of the specified ingredient is determined by predetermining a set of ingredients that users, collectively, would wish to avoid, marking those grocery items having one or more of these ingredients, permitting users to specify which of the ingredients they wish to avoid, and then highlighting those food items with ingredients matching those ingredients identified by the user.

The database 150 can include other records to permit the shopping by recipe feature discussed above with respect to FIGS. 3I and 3J. Individual fields in the recipe records include the name of the recipe, instructions for preparing the recipe, and links to other database records corresponding to the grocery items composing the recipe. This arrangement recipe database records permits the scoring procedure, which will be described in detail below, to treat the recipe records like a normal grocery item record, thus, generating a score for the meal relative to the user's specified nutritional goals. Additional information regarding the types of tables, views and procedures included in the database for the shopping assistance application is located in Addendum B attached hereto.

The assigning of categories to each item or product in the database using a hierarchical organization permits the recommendation of substitute food items by the shopping assistance application. Each child category in the table of categories is associated with a set of numerical values. This set of values for each child category corresponds to multiple sets of four values for each possible nutritional goal available to a user for selection. A first value reflects the lowest score for any food in the child category relative to a particular nutritional goal. A second value reflects the highest score for any food in the same child category relative to that same nutritional goal. A third value reflects the lowest score for any food item in the parent category of the same child category relative to the same nutritional goal. A fourth value reflects the highest score for any food item in the same parent category of the same child category relative to the same nutritional goal.

Using the four numeric values for each child category, it is possible to identify those food items in a shopping list whose replacement would contribute most to a nutritional goal. For each item in the shopping list and a particular nutritional goal, the shopping assistance application computes the difference between the score of the food item and the best scoring item in the food category. The shopping assistance application compares the differences against a threshold value or selects the two or three food items whose substitution would achieve the greatest differences. As shown in FIG. 3B and discussed earlier, those food items whose substitution would achieve the greatest differences are marked with a yellow “Caution” icon, prompting the user to engage in a food substitution dialog.

The information in the database relating to the items or products is quasi-static, i.e., the information is updated or changed on a scheduled non-real time basis. Therefore, the values associated with each child category can be computed once when the database is offline for changes and utilized for all subsequent shopping transactions. The scores for individual food items in the same categories are computed, compared, and sorted from least to greatest. The values of the best and worst scoring food items in a category based on a particular nutritional goal are stored in the table of categories, as discussed above. These values can also be computed in real time on an as-needed basis.

As discussed above, the shopping assistance application assigns a score to a grocery item relative to a specified nutritional goal. To determine or generate the score for a grocery item relative to a specific goal, the shopping assistance algorithm uses one or more scoring algorithms. In determining a score, the algorithms consider the nutritional information associated with the grocery item, the serving size specified by the manufacturer, and the average serving size for similar grocery items. The scoring for compound nutritional goals, e.g., “Less Total Fat, Less Calories,” is determined by averaging the scores resulting from evaluation against each individual nutritional goal.

To generate a score for a product or item, the scoring algorithm first computes the amount of each nutrient in a typical serving size of the food item, e.g. a 100 grams, using the nutritional information and serving sizes previously entered into the database. Preferably, the manufacturer's stated serving size can be used for the calculation, however, adjustments can be made to the stated serving size to account for very large or small serving sizes. In one embodiment, if the manufacturer's serving size is larger than the average serving size for all items in a category, the manufacturer's serving size is used. In another embodiment, if there are multiple servings in a package and the manufacturer's serving size is smaller than the average serving size for the category, the serving size is increased in the direction of the category serving size up to 50% of the manufacturer's serving size. In still another embodiment, if there is only one serving in a package, the manufacturer's serving size shown on the label is used.

Instead of using the manufacturer's serving size as the basis for the calculation, a predetermined amount, e.g. 100 grams, can be used as the basis for the calculation. Using the predetermined amount, provides a fairly accurate assessment of the nutrient content of the product. However, the manufacturer's product information has to be scaled to correspond to the predetermined amount in order to complete the calculation.

These amounts are then sorted by food item, by nutrient. The scoring algorithm selects a high-valued food item to normalize other lower scores. In a preferred embodiment of the present invention, the normalizing item is the highest-valued item in the 98^{th} percentile of the sorted list of grocery items. With a normalizing item selected, lowered-valued items are divided by the normalizing item's score to yield a percentile which is presented as the “score” in the shopping dialogs discussed earlier. If the user's specified nutritional goal is to maximize a nutrient, the score calculated above is used to permit the user to pick an item having a higher score to obtain more of the nutrient. Similarly, if the user's specified nutritional goal is to minimize a nutrient, the score computed above by the scoring algorithm is subtracted from 100, to provide the user with scores that permit the user to best achieve a goal by selecting the highest-scoring item. In another embodiment of the present invention, nutrient amounts exceeding the United States Recommended Daily Allowance (US RDA) are weighted to reduce their contribution to the score for the food item. For example, any amount of nutrient over the RDA is reduced by 50% for nutrients that people may want to increase such as calcium, fiber, vitamins, etc. Thus, a food item having 300% of the RDA of Vitamin C is only judged as being twice as good as a food item with 100% of the RDA of Vitamin C instead of three times as good.

In an alternate embodiment of the present invention, the raw scores as calculated above can be more evenly distributed from 0-100% to avoid clusters around the same values. One method is to scale the raw score between 0-100% and then square the number to attempt to more accurately match user's opinions regarding good and bad foods. Another method is to calculate an average score for each nutrient set using only non-zero nutrient values and then divide the score for the nutrient set by the average score. Furthermore, the shopping assistance application can also compute an overall score for all of the possible goals. To compute the overall score, each goal is assigned a predetermined factor which is multiplied by the item's score for that goal to obtain a modified score. The modified score for each of the goals is then summed to obtain the overall score.

The shopping assistance application when determining item scores may also account for the quantity of food consumed, incorporate food density information into the calculation for a comparison between volume based foods and weighted foods, and provide more sophisticated normalization techniques to obtain a more even distribution of scores in a nutrition set. In addition, the customer may assign weights to goals when more than one goal is selected to obtain a more customized score for the products. The customized score can be obtained by multiplying the score for the goal by the assigned weight of the goal for each of the selected goals and then adding the weighted scores to obtain the customized score.

The present invention also permits a vendor to periodically send updates to a customer. The vendor designates a list of grocery or other items on sale during a predetermined period. For each customer, the list of items on sale is compared against the customer's past grocery purchases. Only those sale items previously purchased by the user are ultimately presented to the user. Presentation can he made through e-mail, an HTML document sent by e-mail, or a customized web page available to a user. Similar functionality can be presented during a shopping session by labeling individual food items with a “SALE” icon, or by adding an additional tab to the shopping interface that presents sales items by department for a particular city during a specified time period.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

[image]

[image]

[image]

[image]

[image]

[image]

[image]

[image]

[image]

[image]

[image]

[image]

[image]

[image]

[image]

[image]

What is claimed is:

1. A method for enabling a user to shop for groceries and nutritional supplements based on predefined nutritional goals, said method comprising the steps:
(a) receiving a predefined nutritional goal;
(b) receiving a list of at least one grocery item;
(c) identifying a grocery item in said list; and
(d) recommending a substitution for said identified grocery item in furtherance of said received goal.

2. The method of claim 1 wherein said recommended substitution is from the same category of grocery items as said identified entry.

3. The method of claim 1 wherein said recommended substitution is derived from substitution choices made by other users.

4. The method of claim 1 wherein said predefined nutritional goal is determined from at least one datum related to a user's medical condition.

5. The method of claim 4 wherein said datum comprises at least one of a food allergy and a digestive intolerance.

6. The method of claim 4 wherein said identified grocery item comprises an ingredient likely to cause an adverse reaction as indicated by said at least one datum related to a user's medical condition.

7. The method of claim 1 wherein step (d) comprises identifying an entry in said list that most effectuates said predefined goal.

8. The method of claim 7 wherein step (d) comprises the steps:
(d-a) selecting an entry from said list;
(d-b) determining the quantum of progress made by substituting said selected entry with a substitute item;
(d-c) iterating steps (d-a) and (d-b) for all items in said list; and
(d-d) providing the entry in said list with the greatest quantum of progress.

9. The method of claim 8 wherein step (d-b) comprises comparing the nutritional value of said selected entry to the nutritional value of a preselected grocery item.

10. The method of claim 9 wherein said preselected grocery item is a grocery item from the same category of grocery items as said selected entry.

11. The method of claim 1 wherein said list comprises a list of past purchases of grocery items.

12. The method of claim 11 wherein said list of past purchases of grocery items are associated a user of the system.

13. A method for enabling meal preparation based on predefined nutritional goals, said method comprising the steps:
(a) receiving a first list of at least one nutritional goal; and
(b) providing at least one recipe for at least one meal in furtherance of said at least one goal in said first list.

14. The method of claim 13 wherein step (b) comprises the steps:
(b-a) receiving a recipe comprising a list of ingredients;
(b-b) altering the received recipe in furtherance of at least one nutritional goal from said first list; and
(b-c) providing said altered recipe.

15. The method of claim 13 further comprising the step: (c) receiving a second list of at least one grocery item, wherein said at least one provided recipe must utilize at least one grocery item in said second list.

16. The method of claim 13 wherein said at least one provided recipe does not utilize any grocery item in said second list.

17. The method of claim 13 wherein said recipe is provided from a database of recipes.

18. A method for enabling grocery shopping based on predefined nutritional goals, said method comprising the steps:
(a) receiving a first list of at least one nutritional goal; and
(b) presenting a list of groceries highlighting individual grocery items which further said goals in said first list.

19. The method of claim 18 wherein said list of groceries is presented hierarchically.

20. The method of claim 18 wherein said list of groceries corresponds to the contents of a grocery store.

21. The method of claim 18 wherein said list of groceries corresponds to a list of past purchases made by a user.

22. The method of claim 21 wherein said list of groceries corresponding to past purchases is sorted by volume of items purchased.

23. The method of claim 21 wherein said list of groceries corresponding to said past purchases is sorted by the frequency of items purchased.

24. The method of claim 19 wherein said hierarchical organization is organized by at least one of food type, nutritional goal, and food category.

25. The method of claim 19 wherein said hierarchical organization sorts non-edible items front edible items.

26. The method of claim 19 wherein said hierarchical organization is presented one level at a time and is user-navigable.

27. A method for enabling grocery shopping based on predefined nutritional goals, said method comprising the steps:
(a) receiving a first list of at least one grocery item; and
(b) presenting nutritional information related to said grocery item using graphical data.

28. The method of claim 27 wherein said graphical data is at least one of a bar graph and a pie chart.

29. A method for enabling grocery shopping based on predefined nutritional goals, said method comprising the steps:
(a) presenting textual material comprising at least one of a nutrition-related article or a trivia question to a user, said textual material comprising at least one hyperlink associated with a food item; and
(b) responding to the selection of at least one hyperlink to enable the end user to purchase the food item referred to in the at least one hyperlink.

30. The method of claim 29 wherein said textual media is selectively presented based on past purchases made by said end user.

31. The method of claim 29 wherein said textual media is selectively presented based on the type of groceries presently being examined by the user.

32. A programmed computer for enabling shopping for groceries and nutritional supplements based on predefined nutritional goals comprising:
a database of nutritional information directed to at least one of groceries and nutritional supplements; and
a database of user information comprising the nutritional goals of an individual user.

33. The programmed computer of claim 32 further comprising a database of past purchases associated an individual user.

34. The programmed computer of claim 32 wherein said database of nutritional information is organized in a tree structure comprising at least one child node and at least one parent node associated with at least one child node, wherein said at least one child node comprises information concerning an individual grocery item including nutritional information concerning the individual grocery item, and said at least one parent node comprises information relating to a shared characteristic relating to the at least one child node associated with it.

35. The programmed computer of claim 32 wherein said shared characteristic comprise at least one of manufacturer data and the type of grocery item.

36. The programmed computer of claim 32 further comprising an interactive connection with a user for receiving information concerning at least one of nutritional goals and grocery items.

37. The programmed computer of claim 32 further comprising a database of recipe information.

38. The programmed computer of claim 32 further comprising mechanisms for order delivery and fulfillment.
